(19) United States
(12) Patent Application Publication
(10) Pub. No.: US 2026/0360367 A1
(43) Pub. Date: Nov. 12, 2026

(54) Voice Authorship Verification System

(71) Applicant: Alvin Williams, JR., Philadelphia, PA (US)

(72) Inventor: Alvin Williams, JR., Philadelphia, PA (US)

(21) Appl. No.: 19/205,732

(22) Filed: May 12, 2025

(51) Int. Cl. G10L 17/02

(52) U.S. Cl. CPC G10L 17/02

(57) ABSTRACT

A system and method for verifying human authorship of voice communications in real time. The invention uses behavioral acoustic fingerprinting to compare incoming voice inputs against a stored speaker baseline, producing an authorship confidence score. The system works with both live and recorded voice content and provides immediate alerts or metadata tagging if authorship is in question. This protocol is applicable in high-stakes environments such as healthcare, aviation, finance, and government.

### CROSS-REFERENCE TO RELATED APPLICATIONS

Not applicable

### STATEMENT REGARDING FEDERALLY SPONSORED RESEARCH OR DEVELOPMENT

None

### 0001. FIELD OF THE INVENTION

The present invention relates to systems and methods for verifying the authorship of spoken communication. Specifically, it covers real-time analysis of voice-based communication (live or recorded) to determine if the speaker is the known, authorized human based on acoustic behavioral fingerprinting.

### 0002. BACKGROUND OF THE INVENTION

With the rise of AI-generated synthetic voices and deepfake audio, it has become increasingly difficult to verify the identity and authorship of spoken content. Existing systems detect anomalies or spoofed calls but do not provide a behavioral authorship scoring protocol. Current systems in banking and telecom rely on voice biometrics for access, not for verifying whether a human truly authored the message being delivered.

### 0003. SUMMARY OF THE INVENTION

The invention provides a system to verify in real-time whether spoken content was authentically authored by a specific human speaker based on a behavioral voiceprint. The system uses a multi-layered approach including behavioral acoustic fingerprinting, real-time speaker matching, and optionally combined stylometry or contextual metadata.

### 0004. SYSTEM COMPONENTS

1. Baseline Voiceprint Module: Captures user's acoustic behavior and stores a behavioral acoustic identity profile.
2. Real-Time Capture Interface: Listens to incoming or live speech and translates it into audio vectors.
3. Authorship Scoring Engine: Compares incoming voice to the baseline and calculates the Prufia Voice Score.
4. Flagging & Feedback: Flags low scores as impersonation and sends real-time alerts.
5. Integration Layer: Embeds system in platforms and preserves authorship metadata in voice-to-text outputs.

### 0005. USE CASE EXAMPLES

1. A voice command from a pilot to air traffic control is verified in real-time.
2. A hospital order given via spoken communication is flagged as potentially spoofed if not authored by the assigned physician.
3. A voicemail left on a CEO's phone is scored at 48 and flagged as non-authentic based on known voice behavior.
4. Use in aviation, healthcare, finance, politics, and national security for real-time command authorship trust.

### 0006. ADVANTAGES

1. First multi-layered system to verify speaker authorship in real time.
2. Integrates behavioral voiceprints, real-time audio scoring, and optional stylometry.
3. Complements existing stylometry and keystroke systems.
4. Establishes the world's first real-time authorship firewall for spoken communication.
5. Forms the voice-based trust layer for secure communication channels.

1. A multi-layered system for verifying the authorship of real-time or recorded voice communication, the system comprising:
a baseline profile module configured to store a behavioral acoustic identity signature of an authorized speaker;
a real-time capture interface configured to extract voice-based behavioral metrics during speech;
an authorship scoring engine configured to compare the extracted metrics against the stored signature to generate a confidence score;
wherein the system integrates two or more behavioral input layers, including but not limited to: acoustic fingerprinting, vocal rhythm, pause frequency, tonal stress, emotional contour, speech stylometry, or contextual signal matching.

2. A computer-implemented method for scoring and flagging the authorship authenticity of voice messages, calls, or commands by comparing live voice input against a stored behavioral profile and generating a real-time authorship confidence score.

3. An authorship scoring engine that calculates and outputs a real-time authorship confidence score for voice communications, and provides immediate feedback or alerts based on whether the score meets a predefined trust threshold.

4. The method of claim 2, further comprising: transcribing the voice communication to text and embedding the authorship score or verification status as metadata within the transcript.

5. The system of claim 1, wherein the verified voice communication occurs in a secure domain including but not limited to: aviation, healthcare, finance, law enforcement, national security, or enterprise communications, and wherein authorship integrity is critical to operational trust.
